(19) United States
(12) Patent Application Publication
(10) Pub. No.: US 2005/0144420 A1
(43) Pub. Date: Jun. 30, 2005

(54) Data processing apparatus and compiler apparatus

(76) Inventors: Shohei Michimoto, Takatsuki-shi (JP); Hajime Ogawa, Suita-shi (JP); Taketo Heishi, Osaka-shi (JP); Kiyoshi Nakashima, Takatsuki-shi (JP); Hazuki Okabayashi, Hirakata-shi (JP); Ryuta Nakanishi, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/995,148

(22) Filed: Nov. 24, 2004

(30) Foreign Application Priority Data
Dec. 25, 2003 (JP) 2003-430546

(51) Int. Cl. G06F 12/08

(52) U.S. Cl. 711/203; 711/144

(57) ABSTRACT

The data processing apparatus capable of efficiently using a cache memory includes: a cache memory 28 and a memory 30 that stores an instruction or data in each area specified by a physical address; an arithmetic processing unit 22 that outputs a logical address including the physical address and process determining data indicating a prescribed process, obtains the instruction or the data corresponding to the physical address included in the logical address, and execute the instruction; an address conversion unit 26 that converts the logical address outputted by the arithmetic processing unit 22 into the physical address. The data processing apparatus reads the instruction or the data stored in areas specified by the physical address, in the cache memory 28 and the memory 30, and executes a prescribed process based on the process determining data.

### BACKGROUND OF THE INVENTION

(1) Field of the Invention

The present invention relates to a data processing apparatus and a compiler apparatus, and particularly to a data processing apparatus having a cache memory, and a compiler apparatus generating a machine language program executed in the data processing apparatus.

(2) Description of the Related Art

In a data processing apparatus (computer) having a cache memory, various ideas for improving cache memory hit rate are employed.

For example, a method is proposed, in a conventional data processing apparatus provided with a cache memory, in which two-dimensionally arrayed data is divided into tile-like segments, with calculation being performed for each array corresponding to each of the tiles (refer to official publication of Japanese Laid-Open Patent Application No. 8-297605, for example). The hit rate of the cache memory can be improved in this method as the spatial locality of data is utilized.

However, as the data processing apparatus described in official publication of Japanese Laid-Open Patent Application No. 8-297605 targets two-dimensionally arrayed data, it cannot be applied for other forms of data access. For this reason, there exists the issue of not always being able to use the cache memory efficiently.

### SUMMARY OF THE INVENTION

The present invention is conceived in view of the aforementioned issues and has as a first objective, providing a data processing apparatus capable of efficient cache memory use even for accessing data other than two-dimensionally arrayed data.

Furthermore, the second objective of the present invention is to provide a compiler apparatus for generating a machine language program executed in a data processing apparatus capable of efficient cache memory use even for accessing data other than two-dimensionally arrayed data.

In order to achieve the aforementioned objectives, the data processing apparatus according to the present invention is a data processing apparatus comprising a storage unit operable to store an instruction or data in each area specified by a physical address, an instruction execution unit operable to i) output a logical address which includes the physical address and process determining data indicating a prescribed process, ii) obtain the instruction or the data corresponding to said physical address included in the logical address, and iii) execute said instruction, and an address conversion unit operable to convert the logical address outputted by the instruction execution unit into the physical address, wherein the storage unit reads the instruction or the data stored in the area specified by the physical address, and executes a process specified based on the process determining data.

Aside from the physical address, the logical address includes process determining data indicating a process. The storage unit containing the command or data executes a process specified based on the process determining data. For this reason, it becomes possible to efficiently use the storage unit for data, and so on.

For example, the storage unit includes a memory operable to store the instruction or the data in each area specified by the physical address, a cache memory operable to store the instruction or the data in each area specified by the physical address, the cache memory being capable of greater high-speed data reading and writing than the memory, and a process execution unit operable to execute the process specified based on the process determining data, the process determining data included in the logical address includes prefetch correspondence data corresponding to a process that prefetches, and stores in the cache memory, the instruction or the data stored in the memory, and in the case where the instruction execution unit accesses the logical address including the prefetch correspondence data, the process execution unit prefetches and stores in the cache memory, the instruction or the data stored in a storage area of the memory, the storage area being identified by the physical address outputted by the address conversion unit.

In this manner, it is possible to judge from the logical address whether or not to prefetch data into the cache memory. As such, together with the enabling of high-speed data access, efficient use of the cache memory also becomes possible.

The compiler apparatus according to the other aspect of the present invention is a compiler apparatus that converts a source program written in high-level programming language into a machine language program, comprising an intermediate code conversion unit operable to convert a source code included in the source program into an intermediate code, an optimization unit operable to optimize the intermediate code, and a code generation unit operable to convert the optimized intermediate code into a machine language instruction, wherein the optimization unit includes a logical address generation unit operable to generate, based on the intermediate code, a logical address by adding process determining data to a physical address used when data is accessed, the process determining data indicating a prescribed process, and an intermediate code generation unit operable to generate an intermediate code for accessing the data, using the logical address.

Aside from the physical address, the logical address includes process determining data indicating a prescribed process. The compiler apparatus generates the intermediate code for accessing data using the logical address. For this reason, it becomes possible to execute a prescribed process in time with the access of data.

For example, the process determining data includes prefetch correspondence data corresponding to a process that prefetches data stored in a memory and stores the prefetched data into a cache memory, the aforementioned compiler apparatus further comprises an analysis unit operable to analyze data which causes a cache miss, and a location of said cache miss-causing data, the logical address generation unit includes a prefetch judging unit operable to judge, for each access of the data included in the intermediate code, whether or not data to be accessed needs to be previously stored in the cache memory before said access is performed, said judgment being based on an analysis result from the analysis unit, and a prefetch correspondence data adding unit operable to generate a logical address by adding the prefetch correspondence data to a physical address of the data, in the case where the prefetch judging unit judges that said data needs to be previously stored in the cache memory before said access is performed.

In this manner, it becomes possible to execute a process for prefetching, before the data access. As such, it is possible to use a cache memory efficiently. Furthermore, it is possible to generate a machine language program executed in a data processing apparatus executing the process.

Moreover, the present invention can be realized not only as a data processing apparatus including these characteristic units, or a compiler apparatus including the characteristic units. The present invention can also be realized as a program containing the characteristic instructions, or a compiling method having, as steps, the characteristic units included in the compiler apparatus, or a program that causes a computer to execute the method. In addition, it goes without saying that such a program can be distributed via a recoding medium such as a CD-ROM, a transmission medium such as the internet, and so on.

According to the present invention, it is possible to provide a data processing apparatus capable of efficiently using a cache memory.

Furthermore, it is possible to provide a compiler apparatus that generates a machine language program executed in a data processing apparatus capable of efficiently using a cache memory.

### FURTHER INFORMATION ABOUT TECHNICAL BACKGROUND TO THIS APPLICATION

The disclosure of Japanese Patent Application No. 2003-430546 filed on Dec. 25, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram of the outside appearance of the data processing apparatus according to the embodiments of the present invention.

FIG. 2 is a diagram showing the main hardware configuration of the data processing apparatus shown in FIG. 1.

FIG. 3 is a diagram showing the bit structure of a logical address.

FIG. 4 is a diagram for explaining the correspondence relation of a logical address space and a physical address space.

FIG. 5 is a flowchart of the process in the case where memory access is performed using the fetch space logical address.

FIG. 6 is a flowchart of the process in the case where memory access is performed using the prefetch space logical address.

FIG. 7 is a flowchart of the process in the case where memory access is performed using the area booking space logical address.

FIG. 8 is a flowchart explaining in detail the area booking process (S50) shown in FIG. 7.

FIG. 9 is a flowchart of the process in the case where memory access is performed using the uncacheable space logical address.

FIG. 10 is a flowchart of the process in the case where memory access is performed using the value updating space logical address.

FIG. 11 is a diagram showing the configuration of the compiler apparatus generating an execute form program executed by the data processing apparatus 20.

FIG. 12 is a flowchart of the process executed by the logical address determining unit 46.

FIGS. 13A to 13D are diagrams showing examples of source programs in which data subspace is designated by pragma.

FIGS. 14A and 14B are diagrams showing examples of source programs in which data subspace is designated by a built-in function.

FIGS. 15A to 15C are diagrams showing examples of source programs in the case where there is no user designation such as pragma, a built-in function, or the like.

### DESCRIPTION OF THE PREFERRED EMBODIMENT(S)

Explanation regarding the data processing apparatus according to the embodiment of the present invention shall be made with reference to the diagrams.

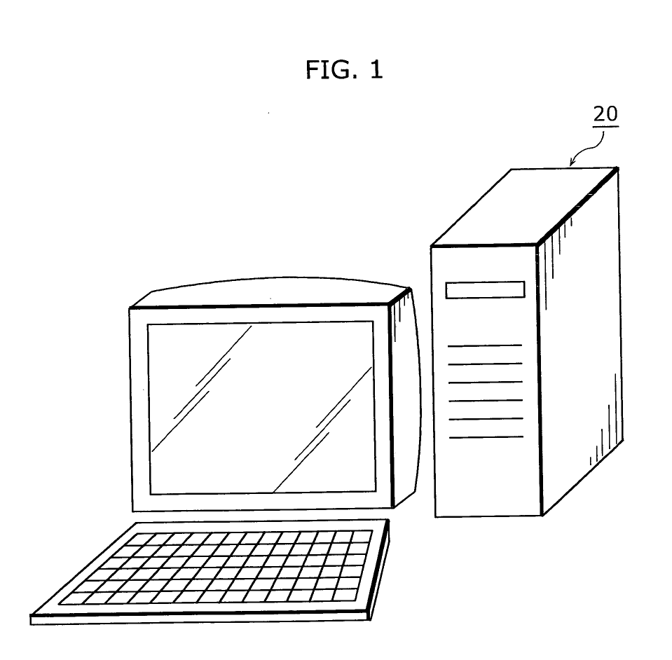

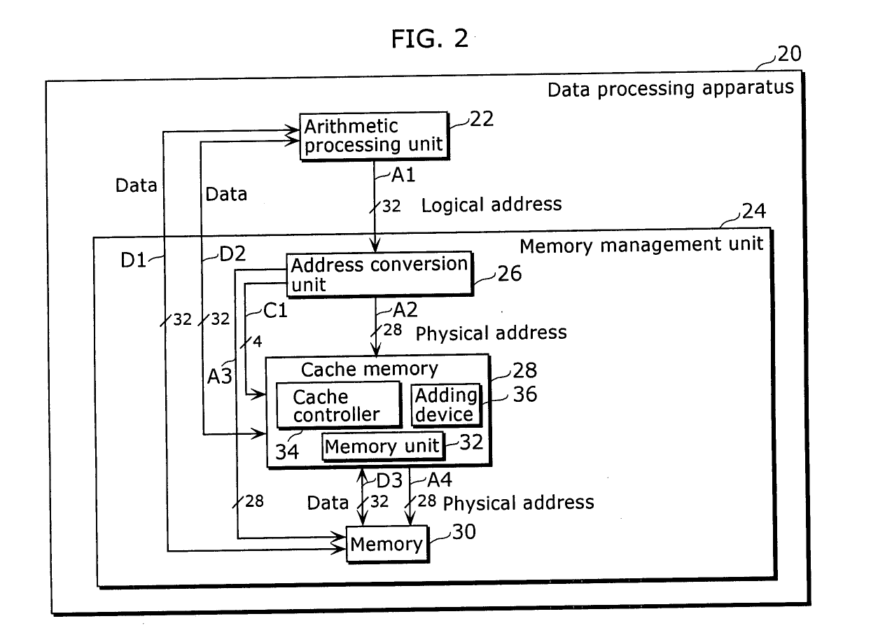

FIG. 1 is a diagram of the outside appearance of a data processing apparatus. FIG. 2 is a diagram showing the main hardware configuration of the data processing apparatus in FIG. 1. A data processing apparatus 20 is an apparatus which executes processes according to an execute form program, and includes an arithmetic processing unit 22, and a memory management unit 24.

The arithmetic processing unit 22 exchanges data (including the program described above) with the memory management unit 24, and is a processing unit that performs computations according to the program described above. The arithmetic processing unit 22 accesses the memory management unit 24 via an address bus A1, by using a 32-bit logical address to be discussed later. It writes and reads data to and from the memory management unit 24 via a data bus D1 or D2.

The memory management unit 24 is a processing unit for managing various memories for storing data, and includes an address conversion unit 26, a cache memory 28, and a memory 30.

The address conversion unit 26 is a processing unit for converting a 32-bit logical address received from the arithmetic processing unit 22 via the address bus A1, into a 28-bit physical address to be discussed later. Furthermore, using the physical address, the address conversion unit 26 accesses the cache memory 28 and memory 30 via an address bus A2 and A3 respectively. In addition, the address conversion unit 26 transmits a control signal for controlling the cache memory 28, to the cache memory 28 via a control signal bus C1.

The cache memory 28 is a high-speed accessible storage apparatus having greater access speed than the memory 30, and includes a memory unit 32 for storing data, a cache controller 34 for performing the various controls for the cache memory 28, and an adding device 36. The cache controller 34 accesses the memory 30 via an address bus A4, and writes and reads data to and from the memory 30 via a data bus D3.

The memory 30 is a storage apparatus for storing data. Each byte data stored in the memory 30 is specified by a 28-bit physical address. As such, the memory 30 has a storage capacity of 256 mega (=2²⁸) bytes.

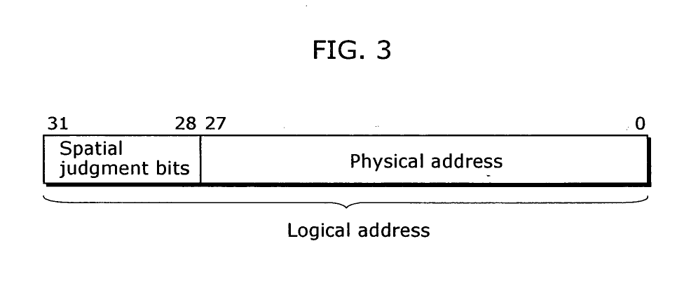

FIG. 3 is a diagram showing the bit configuration of a logical address. As described above, a logical address is composed of 32 bits. The lower 28 bits are equivalent to the physical address and the higher 4 bits (hereinafter referred to as “space determining bits”) are to be used in space determination to be discussed later. In other words, the logical address can be indicated by a value within the range of [0×00000000]˜[0×FFFFFFFF], when expressed as a hexadecimal. Among these, the higher first digit is used in space determination. Accordingly, a maximum of 16 spaces can be defined.

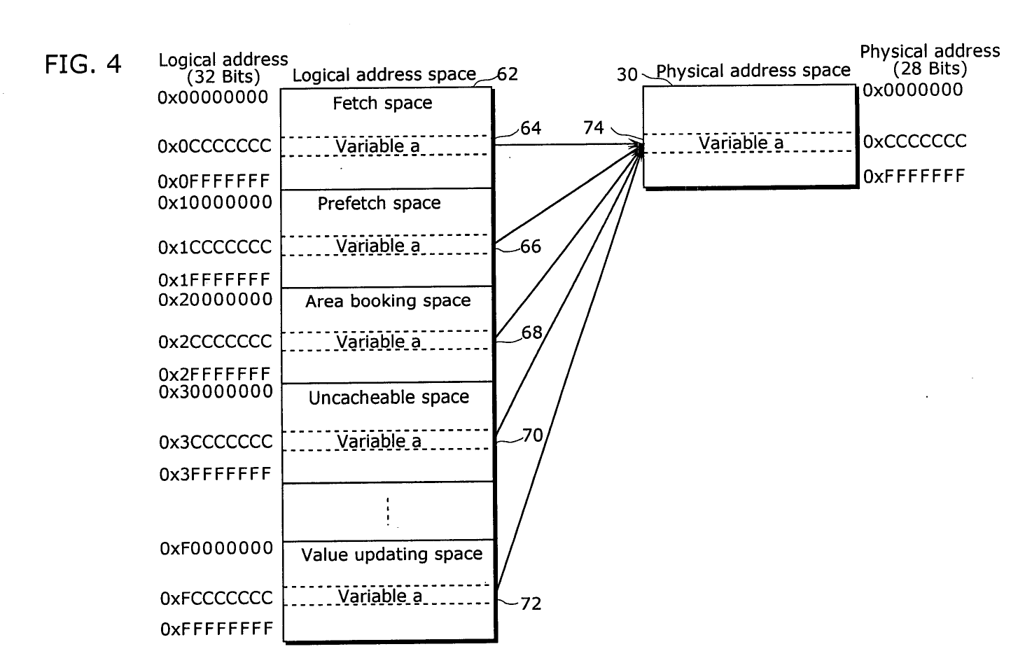

FIG. 4 is a diagram for explaining the correspondence relation of a logical address space and a physical address space. The logical address space is divided into 16 subspaces, and each subspace is specified by space determining bits. The storage capacity of each subspace is the same as the memory 30, at 256 mega bytes. Accordingly, the size of data that can be specified using the logical address space is 4 giga (=16×256 mega) bytes.

Each subspace is set in a one-to-one correspondence to a physical address space, and as described above, the lower 28 bits of the logical address corresponds to the physical address. As shown in FIG. 4, for example, accessing data 64 (variable a) indicated by logical address [0×0CCCCCCC] means accessing data 74 (variable a) stored at physical address [0×CCCCCCC] of the memory 30. Here, every subspace is set to correspond to a process. In the diagram, a “fetch space”, “prefetch space”, “area booking space”, “uncacheable space” and “value updating space”, are shown as examples of a subspace.

The logical address of the “fetch space” is [0×00000000]˜[0×0FFFFFFF]. The logical address of the “prefetch space” is [0×10000000]˜[0×1FFFFFFF]. The logical address of the “area booking space” is [0×20000000]˜[0×2FFFFFFF]. The logical address of the “uncacheable space” is [0×30000000]˜[0×FFFFFFF]. The logical address of the “value updating space” is [0×F0000000]˜[0×FFFFFFFF]. In other words, the difference of the subspaces is indicated by the starting 4 bits of the logical address.

The “fetch space” refers to logical address space used for performing the same process as a memory access in a normal data processing apparatus having a cache memory. For example, when the arithmetic processing unit 22 accesses data 64 (variable a) indicated by the logical address [0×0CCCCCCC] of the “fetch space”, in the case where the “variable a” is stored in the cache memory 28, the “variable a” is forwarded from the cache memory 28 to the arithmetic processing unit 22. In the case where the “variable a” is not stored in the cache memory 28, data 74 (variable a) stored at the physical address [0×CCCCCCCC] of the memory 30 is forwarded to the cache memory 28, after which the data is forwarded to the arithmetic processing unit 22.

The “prefetch space” refers to the logical address space used for prefetching desired data in advance, into the cache memory 28. For example, when the arithmetic processing unit 22 accesses data 66 (variable a) indicated by the logical address [0×1CCCCCCC] of the “prefetch space”, data 74 (variable a) stored at the physical address [0×CCCCCCCC] of the memory 30 is prefetched into the cache memory 28.

The “area booking space” refers to the logical address space used for booking an area for storing desired data in the cache memory 28. The area booking space is utilized in the accessing of data used in a process that begins from the writing-in of a value. Even if the data is prefetched into the cache memory 28 in advance, this data is quickly rewritten. For this reason, data is not prefetched into the cache memory 28, and only the booking of an area is performed. For example, when the arithmetic processing unit 22 accesses data 68 (variable a) indicated by the logical address [0×2CCCCCCC] of the “area booking space”, data 74 (variable a) stored at the physical address [0×CCCCCCCC] of the memory 30 is not stored in the cache memory 28, and an area for storing a “variable a” is booked in the cache memory 28. Moreover, the area is set to correspond to the physical address [0×CCCCCCCC] of the memory 30.

The “uncacheable space” refers to the logical address space used when desired data is written or read directly to or from the memory 30, without going through the cache memory 28. For example, when the arithmetic processing unit 22 accesses data 70 (variable a) indicated by the logical address [0×3CCCCCCC] of the “uncacheable space”, data 74 (variable a) stored at the physical address [0×CCCCCCCC] of the memory 30 is forwarded to the arithmetic processing unit 22 without being stored in the cache memory 28.

The “value updating space” refers to the logical address space used for updating desired data according to some form of regulation after the data is accessed. For example, when the arithmetic processing unit 22 accesses data 72 (variable a) by using the logical address [0×FCCCCCCC] of the “value updating space”, the same action as in the “fetch space” is executed. Subsequently, the value of the variable a stored in the cache memory 28 is added with a predetermined value.

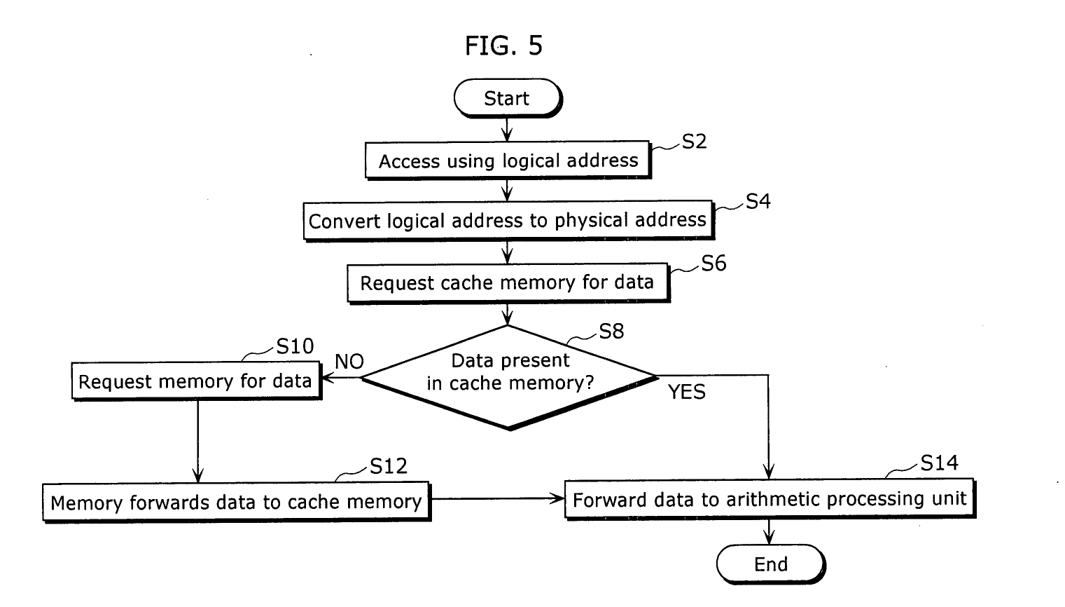

FIG. 5 is a flowchart of the process in the case where memory access is performed using the fetch space logical address. When the arithmetic processing unit 22 performs a memory access using the fetch space logical address (S2), the address conversion unit 26 converts the logical address into a physical address (S4). Judgment as to whether or not memory access using the fetch space logical address was performed, is carried out by the address conversion unit 26, and is judged depending on whether or not the higher 4 bits of the logical address is [0×0] when expressed as a hexadecimal. Furthermore, the conversion from logical address to physical address is carried out through the extraction of the lower 28 bits of the logical address.

The address conversion unit 26 requests the cache memory 28 for the data stored at the physical address (S6). In the case where the data corresponding to the physical address is present in the cache memory 28 (YES in S8), the data is forwarded by the cache memory 28 to the arithmetic processing unit 22. In the case where the data corresponding to the physical address is not present in the cache memory 28 (NO in S8), the cache memory 28 requests the memory 30 for the data stored at the physical address (S10), and the data is forwarded to the cache memory 28 and stored (S12). Subsequently, the cache memory 28 forwards the data to the arithmetic processing unit 22 (S14).

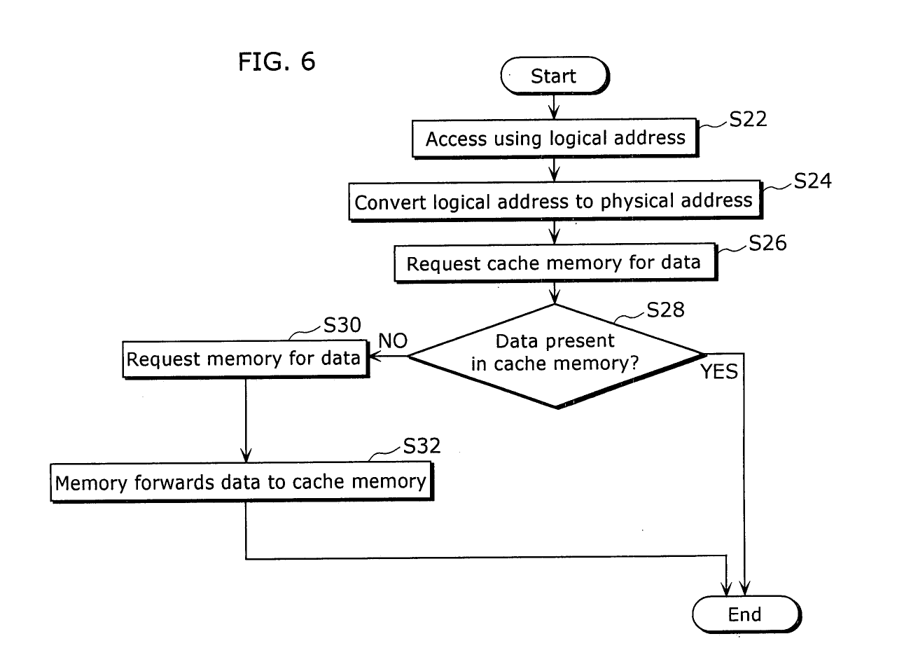

FIG. 6 is a flowchart of the process in the case where memory access is performed using the prefetch space logical address. When the arithmetic processing unit 22 performs a memory access using the prefetch space logical address (S22), the address conversion unit 26 converts the logical address into a physical address (S24). Judgment as to whether or not memory access using the prefetch space logical address was performed, is carried out by the address conversion unit 26, and is judged depending on whether or not the higher 4 bits of the logical address is [0×1] when expressed as a hexadecimal. The conversion from logical address to physical address is as previously described.

The address conversion unit 26 requests the cache memory 28 for the data stored at the physical address (S26). In the case where the data corresponding to the physical address is present in the cache memory 28 (YES in S28), the process is concluded. In the case where the data corresponding to the physical address is not present in the cache memory 28 (NO in S28), the cache memory 28 requests the memory 30 for the data stored at the physical address (S30), and the data is forwarded to the cache memory 28 and stored (S32).

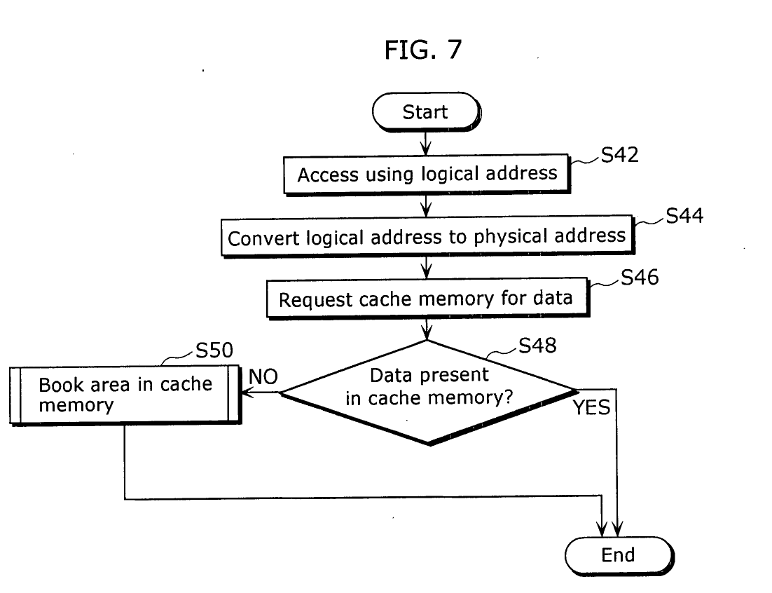

FIG. 7 is a flowchart of the process in the case where memory access is performed using the area booking space logical address. When the arithmetic processing unit 22 performs a memory access using the area booking space logical address (S42), the address conversion unit 26 converts the logical address into a physical address (S44). Judgment as to whether or not memory access using the area booking space logical address was performed, is carried out by the address conversion unit 26, and is judged depending on whether or not the higher 4 bits of the logical address is [0×2] when expressed as a hexadecimal. The conversion from logical address to physical address is as previously described.

The address conversion unit 26 requests the cache memory 28 for the data stored at the physical address (S46). In the case where the data corresponding to the physical address is present in the cache memory 28 (YES in S48), the process is concluded. In the case where the data corresponding to the physical address is not present in the cache memory 28 (NO in S48), the cache memory 28 books an area (block) for storing the data corresponding to the physical address, in the cache memory 28 (S50), and the process is concluded.

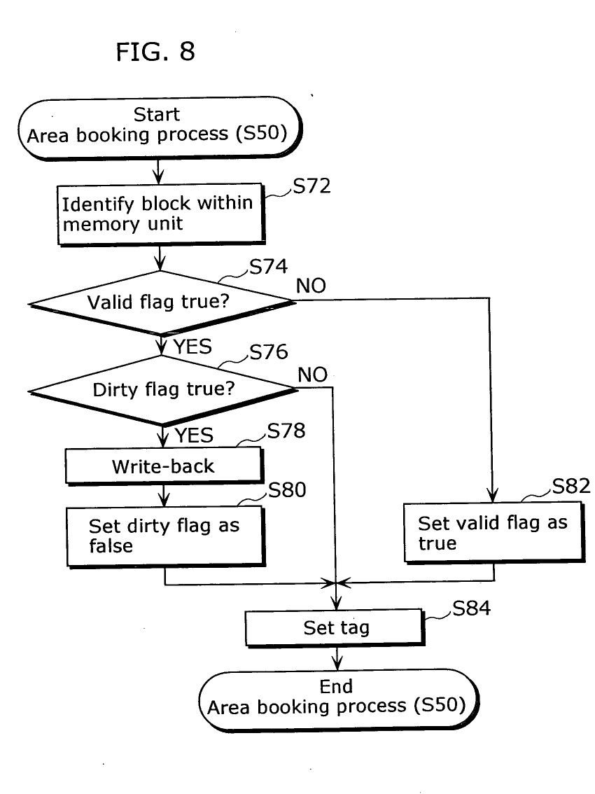

FIG. 8 is a flowchart explaining in detail the area booking process (S50) shown in FIG. 7. The cache controller 34 of the cache memory 28 identifies the block within the memory unit 32, in which the data, stored in the block identified by the physical address obtained through the physical address conversion process (S44 in FIG. 7), is stored (S72). Here, the cache memory 28 is assumed to store data according to the direct mapping scheme. Accordingly, if the physical address is set, the block within the memory unit 32 is uniquely identified. Moreover, the data storage method of the cache memory 28 can be the set-associative scheme or the full-associative scheme. In this case, a block having a valid flag (data for identifying whether or not data stored in a corresponding block is valid) which is false is preferentially identified as the block within the memory unit 32.

After the block within the memory unit 32 is identified, the address conversion unit 26 checks whether or not a valid flag corresponding to the block is true (S74). In the case where the valid flag is false (NO in S74), the valid flag is set as true in order to make the block valid (S82). Subsequently, the tag (physical address) of the block is set (S82) and the process is concluded.

In the case where the valid flag is true (YES in S74), the cache controller 34 checks whether or not a dirty flag corresponding to the block is true (S76). Here, dirty flag refers to a flag which indicates whether or not the data stored in the block is updated with a value which is different to that at the time of storage. In other words, when the dirty flag is true, it indicates that the data stored in the block and the data corresponding to the block, stored in the memory 30, are different. As such, in the case where the dirty flag is true (YES in S76), the cache controller 34 executes a process (write-back) of writing the data stored in the block back into the corresponding storage area in the memory 30 (S78). Subsequently, the cache controller 34 sets the dirty flag as false (S80), and then sets the tag of the block (S84), and the process is concluded.

In the case where the valid flag is true and the dirty flag is false (YES in S74, and NO in S76), the cache controller 34 sets a new tag for the block without carrying out the flag operations (S84), after which the process is concluded.

Thus, a block for storing the data in the cache memory 28 is booked in the manner explained above.

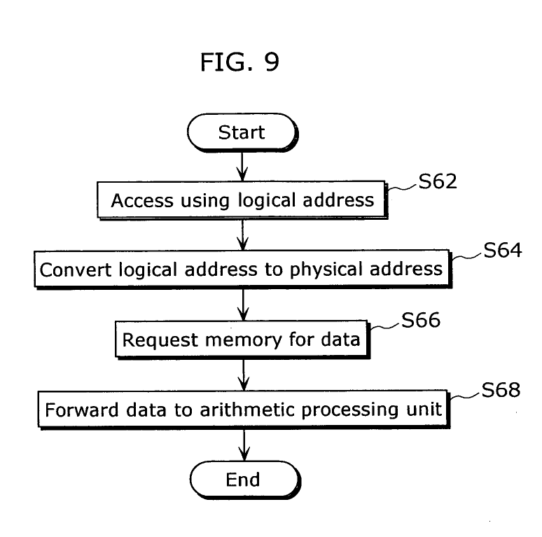

FIG. 9 is a flowchart of the process in the case where memory access is performed using the uncacheable space logical address. When the arithmetic processing unit 22 performs a memory access using the uncacheable space logical address (S62), the address conversion unit 26 converts the logical address into a physical address (S64). Judgment as to whether or not memory access using the uncacheable space logical address was performed, is carried out by the address conversion unit 26, and is judged depending on whether or not the higher 4 bits of the logical address is [0×3] when expressed as a hexadecimal. The conversion from logical address to physical address is as previously described.

The address conversion unit 26 requests data by accessing the memory 30, using the physical address (S66). The memory 30 forwards the data stored in a block indicated by the physical address to the arithmetic processing unit 22 (S68).

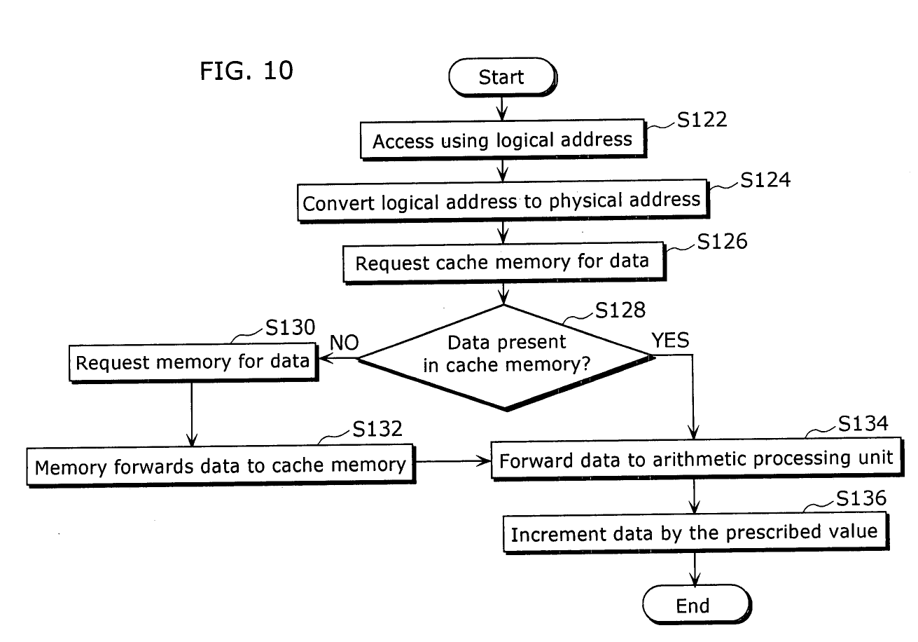

FIG. 10 is a flowchart of the process in the case where memory access is performed using the value updating space logical address. The process up to the point where the arithmetic processing unit 22 obtains data (S122 to S134) is the same as the process (S2 to S14) in the case where the arithmetic processing unit 22 performs a memory access using the fetch space logical address, shown in FIG. 5. As such, details on the process shall not be repeated. After the arithmetic processing unit 22 obtains the data, the cache controller 34 uses the adding device 36 to increment the data by a predetermined value (S136), and the process is concluded.

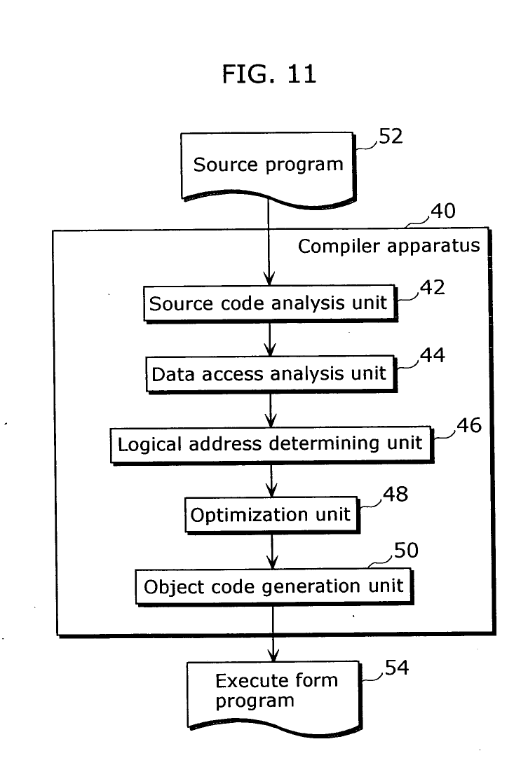

FIG. 11 is a diagram showing the configuration of the compiler apparatus generating an execute form program executed by the data processing apparatus 20.

A compiler apparatus 40 is an apparatus for converting a source program 52 written in high-level programming language such as C language, into an execute form program 54 that can be executed by the data processing apparatus 20. The compiler apparatus 40 includes a source code analysis unit 42, a data access analysis unit 44, a logical address determining unit 46, an optimization unit 48, and an object code generation unit 50.

The source code analysis unit 42 is a processing unit that converts, based on a fixed rule, each statement of the source program 52 into an intermediate code after extraction and lexical analysis of keywords, and the like, from the source program 52 to be compiled.

The data access analysis unit 44 is a processing unit for analyzing data, locations, or the like, which will likely cause a cache miss, based on the location pattern, and so on, of data for memory access. As the process executed by the data access analysis unit 44 is not the main subject of the present specification, detailed explanation shall be omitted.

The logical address determining unit 46 is a processing unit for checking which subspace within a logical address space the data for memory access is located, and determining the logical address of the data. The process executed by the logical address determining unit 46 shall be described later.

The optimization unit 48 is a processing unit that performs optimization processes, except the logical address determination process.

The object code generation unit 50 is a processing unit for generating an object code from an optimized intermediate code, and generating the execute form program 54 by linking with various library programs (not illustrated), and the like.

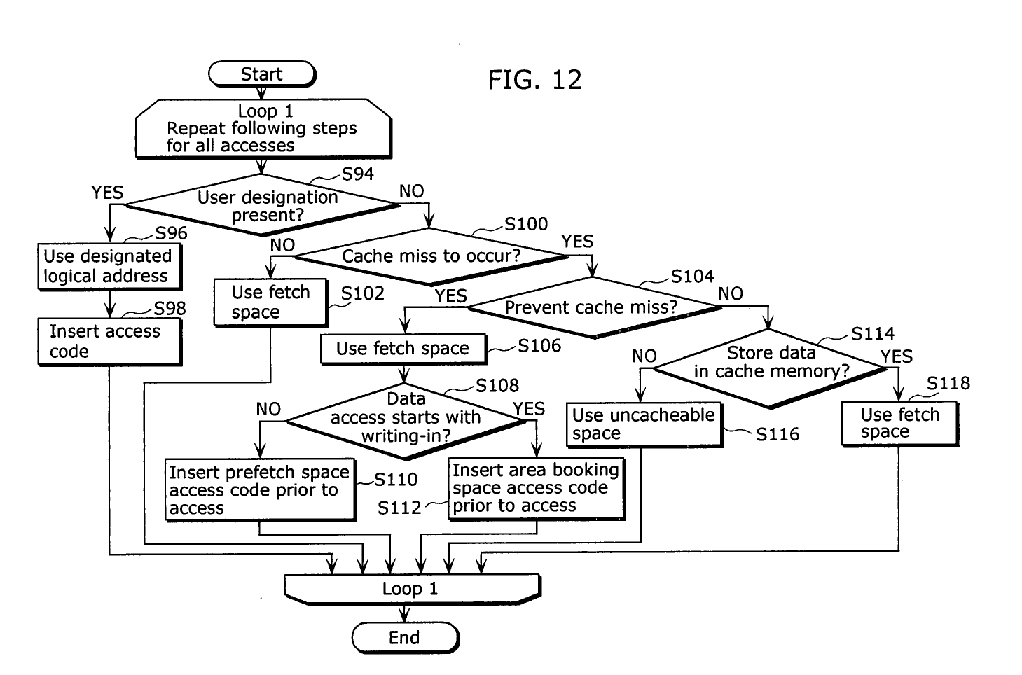

FIG. 12 is a flowchart of the process executed by the logical address determining unit 46. The logical address determining unit 46 individually repeats the following process for all data access included in the intermediate code. First, the logical address determining unit 46 checks, with regard to the access concerned, whether or not there is a designation from a user as to which subspace of the logical address space is to be used in the access (S94). A designation method using a pragma and a designation method using a built-in function exist as designations from the user.

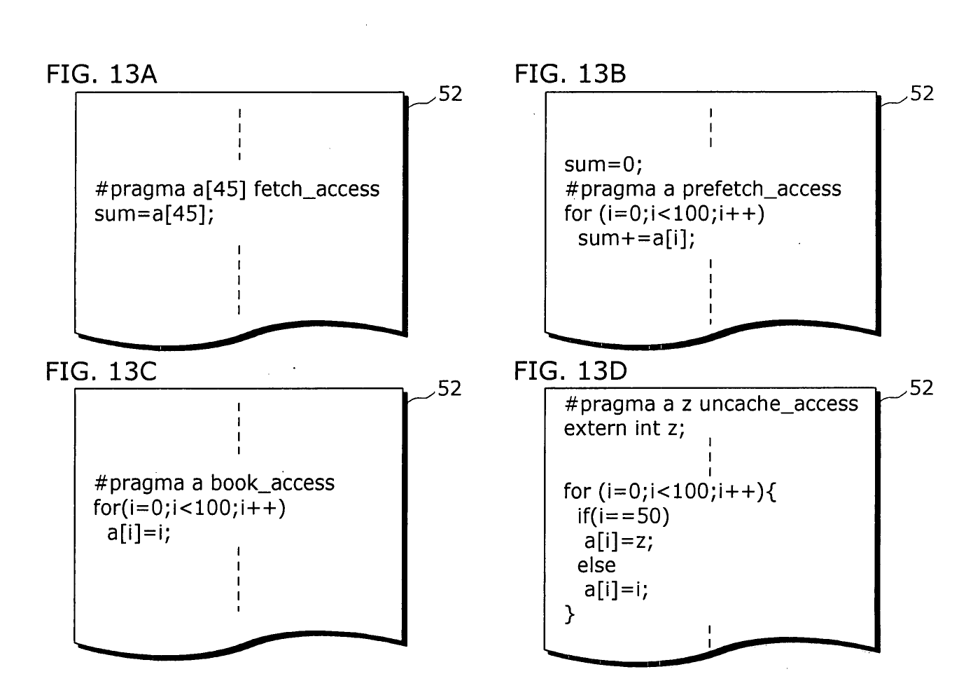

“Pragma” is a directive provided within the source program 52, for the compiler apparatus 40. FIGS. 13A to 13D are diagrams showing examples of source programs in which data subspace is designated according to a pragma.

“#pragma a[45] fetch_access” in FIG. 13A is a directive to the compiler apparatus 40 stating “when accessing an array element a[45], perform the access using the fetch space logical address”.

“#pragma a prefetch_access” in FIG. 13B is a directive to the compiler apparatus 40 stating “prefetch an array a into the cache memory 28, before the access of the array a takes place”.

“#pragma a book _access” in FIG. 13C is a directive to the compiler apparatus 40 stating “previously book an area for storing an array a in the cache memory 28”.

“#pragma z uncache_access” in FIG. 13D is a directive to the compiler apparatus 40 stating “when accessing a variable z, perform the access using the uncacheable space logical address”.

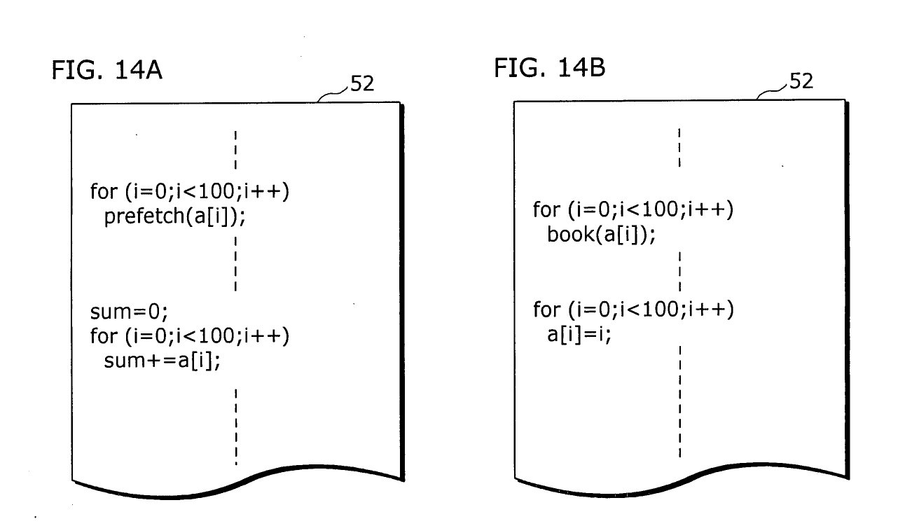

FIGS. 14A and 14B are diagrams showing examples of source programs in which data subspace is designated according to a built-in function. “prefetch (a[i])” in FIG. 14A is a built-in function in which a directive to prefetch an array element a[i] is described. “book (a[i])” in FIG. 14B is a built-in function in which a directive to book a block in the cache memory, for storing an array element a[i] is described.

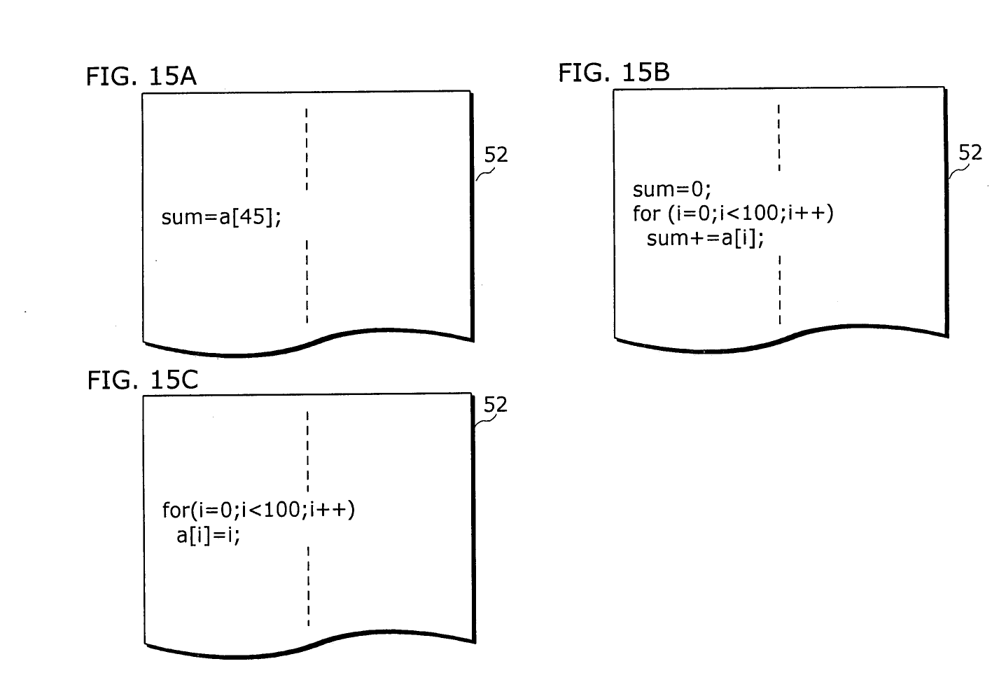

FIGS. 15A to 15C are diagrams showing examples of source programs in the case where there is no user designation such as the pragma or built-in function. FIG. 15A indicates a process where the value of an array element a[45] is substituted for a variable sum. FIG. 15B indicates a process where each element of an array a is sequentially added to a variable sum. FIG. 15C indicates a process where the value of a loop counter i is sequentially substituted for an array element a[i].

In the case where there is a user designation according to a pragma or a built-in function, as shown in FIGS. 13A to 14B (YES in S94), a logical address complying with the designation is used (S96). For example, assuming that the physical address of an array element a[45] is [0×1234567] for the pragma designation in FIG. 13A, a logical address [0×01234567] is created by adding the 4-bit data [0×0] indicating the fetch space, to the head of the physical address. The logical address will be used when the array element a[45] is accessed.

Next, if necessary, the logical address determining unit 46 executes the insertion of an access code (S98). The insertion of an access code is carried out in the case of data access using the prefetch space, as well as data access using the area booking space.

For example, in the case where data access using the prefetch space is designated according to a pragma, as shown in FIG. 13B, the prefetching of data needs to be completed by the time the data access is actually performed. As such, in consideration of memory access latency, a prefetch space access code is inserted in the optimal location in the intermediate code. The detailed process for the prefetch space access code is as explained with reference to FIG. 6.

In the case where data access using the prefetch space is designated according to a built-in function, as shown in FIG. 14A, a prefetch space access code is inserted into the location in the intermediate code corresponding to the location in which the built-in function is described. As such, the location of the built-in function within the source program must be determined by a programmer, giving due consideration towards memory access latency.

In the case of the designation according to a pragma, for data access using the area booking space shown in FIG. 13C, as well as the designation according to a built-in function, for data access using the area booking space shown in FIG. 14B, an area booking space access code is inserted in the same manner as in the case of the designation for data access using the prefetch space. The detailed process for the area booking space access code is as explained with reference to FIG. 7.

In the case where there is no user designation with regard to the data access (NO in S94), the logical address determining unit 46 checks, based on an analysis result from the data access analysis unit 44, whether or not a cache miss will occur during the data access (S100). In the case where a cache miss will not occur (NO in S100), a logical address for performing the data access using the fetch space is generated, and a code for carrying out the data access using the logical address is generated (S102).

In the case where a cache miss will occur (YES in S100), the logical address determining unit 46 judges whether or not there is a need to prevent the cache miss (S104). For example, this judgment can be made to comply with a compile option, and the like.

In the case where there is a need to prevent the cache miss (YES in S104), a code for performing the access of the data using the fetch space is generated (S106). Next, the logical address determining unit 46 checks, based on the analysis result from the data access analysis unit 44, whether or not the data will be used in a process which starts by writing data into the area where the data is to be stored (S108). In other words, it checks whether or not the data will be updated without being referenced. For example, as in the array element a[i] shown in FIG. 15C, there is no need to prefetch data into the cache memory 28 prior to the access as the value of the variable i is written in without the value of the array element a[i] being referenced (YES in S108). For this reason, a block for storing the data is booked in the cache memory 28, prior to the access of the data. As such, an area booking space access code is inserted. The location in which the area booking space access code is inserted is determined, with consideration given to memory access latency. In addition, the detailed process for the area booking space access code is as explained with reference to FIG. 7.

In the case where the data to be accessed will be used in a process other than one which starts by writing-in data (for example, the array element a[i] shown in FIG. 15B) (NO in S108), the data is prefetched into the cache memory 28 prior to access, as data access is performed at high-speed. For this reason, a prefetch space access code is inserted. The location in which the prefetch space access code is inserted is determined with consideration being given to memory access latency, and the insertion is made at a location in which prefetching is completed at the point where the data is actually accessed. In addition, the detailed explanation for the prefetch space access code is as explained with reference to FIG. 6.

In the case where there is no need to prevent the cache miss (NO in S104), the logical address determining unit 46 judges, based on the analysis result from the data access analysis unit 44, whether or not the data in focus needs to be stored in the cache memory 28 (S114). For example, in the case where frequently used data is expelled and a cache miss is caused as a result of storing the data in the cache memory, or the case of data that will only be used once (for example, the array element a[45] shown in FIG. 15A), or the like, it is judged that there is no need to store the data in the cache memory 28. In all other cases, it is judged that storage is required.

In the case where it is judged that there is a need to store the data in focus in the cache memory 28 (YES in S114), a code for accessing the data using the fetch space of the logical address space is generated (S118). In other words, the logical address is created by adding the 4-bit data [0×0] indicating the fetch space, to the head of the physical address.

In the case where it is judged that there is no need to store the data in focus in the cache memory 28 (NO in S114), a code for accessing the data using the uncacheable space of the logical address space is generated (S116). In other words, the logical address is created by adding the 4-bit data [0×3] indicating the uncacheable space, to the head of the physical address.

The logical address determining unit 46 executes the above process (S94 to S118) for all data accesses (loop 1), and the process is concluded.

As explained above, according to the embodiment of the present invention, access to data is performed using a logical address created by having space determining bits attached to the physical address. For this reason, it is possible to add a prescribed process to the data access. For example, as described above, it is possible to prefetch data into the cache memory prior to data access. As such, it becomes possible to use the cache memory efficiently.

Furthermore, it is also possible to provide a compiler apparatus for generating a machine language program executed in such a data processing apparatus.

It should be noted that the embodiment explained above is only one example of the present invention, and the present invention should not be limited to the embodiment described above.

For example, the aforementioned subspace of the logical address space is only one example, and it is possible to have other processes executed. For example, the value updating method for the “value updating space” is not limited only to addition. It is also possible to have the four fundamental arithmetic operations, such as subtraction, multiplication, division, and so on, or even logical operations. Furthermore, it is also possible to update values by executing more complex processes.

Furthermore, it is also possible to perform the execution directives of other hardware included in the data processing apparatus by accessing the subspace. For example, it is possible to have a “directive space to hardware A”, as an example of a subspace. In the case where data is accessed using the logical address of this subspace, the data is read from the cache memory 28 or the memory 30, and forwarded to the hardware A. The hardware A starts a process, with the forwarding of the data acting as a trigger. Moreover, at such time, it is also possible to have the hardware A perform a prescribed process using the data. Furthermore, it is possible to have a “directive space to hardware B” as another example of a subspace. In the case where data is accessed using the logical address of this subspace, the hardware B starts a prescribed process, with the access of the data acting as a trigger.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a processor, or the like, having a cache memory.

1. A data processing apparatus comprising:
a storage unit operable to store an instruction or data in each area specified by a physical address;
an instruction execution unit operable to i) output a logical address which includes the physical address and process determining data indicating a prescribed process, ii) obtain the instruction or the data corresponding to said physical address included in the logical address, and iii) execute said instruction; and
an address conversion unit operable to convert the logical address outputted by the instruction execution unit into the physical address,
wherein the storage unit reads the instruction or the data stored in the area specified by the physical address, and executes a process specified based on the process determining data.

2. The data processing apparatus according to claim 1,
wherein the storage unit includes:
a memory operable to store the instruction or the data in each area specified by the physical address;
a cache memory operable to store the instruction or the data in each area specified by the physical address, the cache memory being capable of greater high-speed data reading and writing than the memory; and
a process execution unit operable to execute the process specified based on the process determining data,
the process determining data included in the logical address includes fetch correspondence data corresponding to a process that fetches, and stores in the cache memory, the instruction or the data stored in the memory, and
in the case where the instruction execution unit accesses the logical address including the fetch correspondence data, the process execution unit fetches and stores in the cache memory, the instruction or the data stored in a storage area of the memory, the storage area being identified by the physical address outputted by the address conversion unit.

3. The data processing apparatus according to claim 1,
wherein the storage unit includes:
a memory operable to store the instruction or the data in each area specified by the physical address;
a cache memory operable to store the instruction or the data in each area specified by the physical address, the cache memory being capable of greater high-speed data reading and writing than the memory; and
a process execution unit operable to execute the process specified based on the process determining data,
the process determining data included in the logical address includes prefetch correspondence data corresponding to a process that prefetches, and stores in the cache memory, the instruction or the data stored in the memory, and
in the case where the instruction execution unit accesses the logical address including the prefetch correspondence data, the process execution unit prefetches and stores in the cache memory, the instruction or the data stored in a storage area of the memory, the storage area being identified by the physical address outputted by the address conversion unit.

4. The data processing apparatus according to claim 1,
wherein the storage unit includes:
a memory operable to store the instruction or the data in each area specified by the physical address;
a cache memory operable to store the instruction or the data in each area specified by the physical address, the cache memory being capable of greater high-speed data reading and writing than the memory; and
a process execution unit operable to execute the process specified based on the process determining data,
the process determining data included in the logical address includes area booking correspondence data corresponding to a process that books, in the cache memory, an area for storing the instruction or the data stored in the memory, and
in the case where access of the logical address including the area booking correspondence data is performed according to the instruction execution unit, the process execution unit books, in the cache memory, an area for storing the instruction or the data stored in a storage area of the memory, the storage area being identified by the physical address outputted by the address conversion unit.

5. The data processing apparatus according to claim 1,
wherein the storage unit includes:
a memory operable to store the instruction or the data in each area specified by the physical address;
a cache memory operable to store the instruction or the data in each area specified by the physical address, the cache memory being capable of greater high-speed data reading and writing than the memory; and
a process execution unit operable to execute the process specified based on the process determining data,
the process determining data included in the logical address includes uncacheable correspondence data corresponding to a process that forwards the instruction or the data stored in the memory to the instruction execution unit, without storing said instruction or said data in the cache memory, and
in the case where access of the logical address including the uncacheable correspondence data is performed according to the instruction execution unit, the process execution unit reads the instruction or the data stored in a storage area of the memory without storing said instruction or said data in a storage area of the cache memory, the storage areas being identified by the physical address outputted by the address conversion unit.

6. The data processing apparatus according to claim 1,
wherein the storage unit includes:
a memory operable to store the instruction or the data in each area specified by the physical address;
a cache memory operable to store the instruction or the data in each area specified by the physical address, the cache memory being capable of greater high-speed data reading and writing than the memory; and
a process execution unit operable to execute the process specified based on the process determining data,
the process determining data included in the logical address includes value updating correspondence data corresponding to a process that updates, according to a predetermined regulation, the data stored in the memory or the cache memory after said data is accessed, and
in the case where access of the logical address including the value updating correspondence data is performed according to the instruction execution unit, the process execution unit updates the data stored in a storage area of the memory or the cache memory after said data is accessed, the storage area being identified by the physical address outputted by the address conversion unit.

7. A program that can be executed in a data processing apparatus,
wherein the data processing apparatus includes:
a storage unit operable to store an instruction or data in each area specified by a physical address;
an instruction execution unit operable to i) output a logical address which includes the physical address and process determining data indicating a prescribed process, ii) obtain the instruction or the data corresponding to said physical address included in the logical address, and iii) execute said instruction; and
an address conversion unit operable to convert the logical address outputted by the instruction execution unit into the physical address,
the storage unit reads the instruction or the data stored in the area specified by the physical address, and executes a process specified based on the process determining data, and
the program includes a machine language instruction for accessing the storage unit using the logical address.

8. A compiler apparatus that converts a source program written in high-level programming language into a machine language program, comprising:
an intermediate code conversion unit operable to convert a source code included in the source program into an intermediate code;
an optimization unit operable to optimize the intermediate code; and
a code generation unit operable to convert the optimized intermediate code into a machine language instruction,
wherein the optimization unit includes:
a logical address generation unit operable to generate, based on the intermediate code, a logical address by adding process determining data to a physical address used when data is accessed, the process determining data indicating a prescribed process; and
an intermediate code generation unit operable to generate an intermediate code for accessing the data, using the logical address.

9. The compiler apparatus according to claim 8,
wherein the logical address generation unit includes:
a directive checking unit operable to check, for each access of the data included in the intermediate code, whether or not a directive for a process for said access is included within the source program; and
a process determining data adding unit operable to generate, in the case where said directive is included, a logical address by adding process determining data to a physical address of said data, the process determining data corresponding to a process specified by said directive.

10. The compiler apparatus according to claim 8,
wherein the process determining data includes fetch correspondence data corresponding to a process that fetches data stored in a memory, and stores the fetched data into a cache memory,
the compiler apparatus further comprises
an analysis unit operable to analyze data which causes a cache miss, and a location of said cache miss-causing data,
the logical address generation unit includes:
a cache miss judging unit operable to judge, for each access of the data included in the intermediate code, whether or not data to be accessed causes a cache miss, said judgment being based on an analysis result from the analysis unit; and
a fetch correspondence data adding unit operable to generate a logical address by adding the fetch correspondence data to a physical address of the data, in the case where the cache miss judging unit judges that the data does not cause a cache miss.

11. The compiler apparatus according to claim 8,
wherein the process determining data includes prefetch correspondence data corresponding to a process that prefetches data stored in a memory and stores the prefetched data into a cache memory,
the compiler apparatus further comprises
an analysis unit operable to analyze data which causes a cache miss, and a location of said cache miss-causing data,
the logical address generation unit includes:
a prefetch judging unit operable to judge, for each access of the data included in the intermediate code, whether or not data to be accessed needs to be previously stored in the cache memory before said access is performed, said judgment being based on an analysis result from the analysis unit; and
a prefetch correspondence data adding unit operable to generate a logical address by adding the prefetch correspondence data to a physical address of the data, in the case where the prefetch judging unit judges that said data needs to be previously stored in the cache memory before said access is performed.

12. The compiler apparatus according to claim 8,
wherein the process determining data includes area booking correspondence data corresponding to a process that books an area, in a cache memory, for storing data stored in a memory,
the compiler apparatus further comprises
an analysis unit operable to analyze whether or not data to be accessed is to be used in a process that starts by writing-in data, and
the logical address generation unit generates a logical address by adding the area booking corresponding data to a physical address of the data, in the case where the analysis unit determines that said data is to be used in a process that starts by writing-in data.

13. The compiler apparatus according to claim 8,
wherein the process determining data includes uncacheable correspondence data corresponding to a process that forwards data stored in a memory to an instruction execution unit that executes instructions, without storing said data in a cache memory,
the compiler apparatus further comprises
an analysis unit operable to analyze data which causes a cache miss, and a location of said cache miss-causing data,
the logical address generation unit includes:
a storage judging unit operable to judge, for each access of the data included in the intermediate code, whether or not data to be accessed needs to be stored in the cache memory; and
an uncacheable correspondence data adding unit operable to generate a logical address by adding the uncacheable correspondence data to a physical address of the data, in the case where the storage judging unit judges that the data does not need to be to be stored in the cache memory.

14. A compiling method that converts a source program written in high-level programming language into a machine language program, the method comprising:
converting a source code included in the source program into an intermediate code;
optimizing the intermediate code; and
converting the optimized intermediate code into a machine language instruction,
wherein the optimization includes:
generating, based on the intermediate code, a logical address by adding process determining data to a physical address used when data is accessed, the process determining data indicating a prescribed process; and
generating an intermediate code for accessing the data, using the logical address.

15. A compiler that converts a source program written in high-level programming language into a machine language program, the compiler causing a computer to execute:
converting a source code included in the source program into an intermediate code;
optimizing the intermediate code; and
converting the optimized intermediate code into a machine language instruction,
wherein the optimization includes:
generating, based on the intermediate code, a logical address by adding process determining data to a physical address used when data is accessed, the process determining data indicating a prescribed process; and
generating an intermediate code for accessing the data, using the logical address.
